(19) United States
(12) Patent Application Publication
(10) Pub. No.: US 2008/0118803 A1
(43) Pub. Date: May 22, 2008

(54) Sofc Stack Concept

(75) Inventors: Nicolaas Jacobus Joseph Dekker, Amsterdam (NL); Gerard Jan Kraaij, t Veld (NL); Gijsbertus Rietveld, Alkmaar (NL)

Correspondence Address: THE WEBB LAW FIRM, P.C., 700 KOPPERS BUILDING, 436 SEVENTH AVENUE, PITTSBURGH, PA, 15219, US

(73) Assignee: STICHTING ENERGIEONDERZOEK CENTRUM NEDERLAND, Petten (NL)

(21) Appl. No.: 11/660,456

(22) PCT Filed: Aug. 18, 2005
(86) PCT No.: PCT/NL05/00601

§ 371 Date: Oct. 26, 2007

(30) Foreign Application Priority Data
Aug. 18, 2004 (NL) 1026861

(51) Int. Cl. H01M 8/10

(52) U.S. Cl. 429/30

(57) ABSTRACT

A fuel cell is constructed as anode-supported solid oxide fuel cell, but can also be used with electrolyte- and metal-supported solid oxide fuel cells. The anode and electrolyte are larger than the cathode and the portion of the anode/electrolyte protruding beyond the cathode is provided with a peripheral seal. The anode-/electrolyte/cathode combination is provided with a flow/gas distribution grid on both the anode and the cathode side. The anode/cathode combination including the flow/gas distribution grids is enclosed between two separator plates, an auxiliary plate and a spacer. The auxiliary plate is designed for external feeding and discharge of a cathode gas, while the separator plate and the auxiliary plate are provided with openings for internal feeding/discharge of anode gas. The auxiliary plate and spacer are solder joined to the separator plate. Several fuel cells of the invention can be used to form a cell stack.

The present invention relates to a fuel cell unit comprising an electrolyte with an anode on one side and a cathode on the other side, each provided with a flow/gas distribution grid with gas feed/discharge, wherein a separator plate is adjacent each grid as well as a seal acting on the separator plate. A fuel cell unit is understood to be a fuel cell with associated current collectors and the like and separator plates. The actual fuel cell consists of a cathode, electrolyte and anode.

A fuel cell stack where the gas feed/discharge for the cathode comprises channels extending from the cathode to beyond the peripheral boundary of the separator plates is disclosed in U.S. Pat. No. 6,777,126. As a consequence of the chosen lay out, the concept described in U.S. Pat. No. 6,777,126 can only be used with cells with a continuous electrolyte, such as the solid polymer, the molten carbonate and electrolyte-supported solid oxide fuel cells. Because of the vulnerability in respect of fracture of the ceramic electrolyte of the electrolyte-supported solid oxide fuel cells, the applicability of this type of cell in this concept is hardly conceivable; the application of the solid oxide fuel cell is not mentioned in the concept of patent U.S. Pat. No. 6,777,126.

U.S. 2003/0203267 discloses a fuel cell where the seal with respect to the separator plate comprises an insulator in combination with a metallic foil, such as a very thin silver foil.

Stacks are made with such fuel cell units in order to create sufficient voltage. In order to gain acceptance for such fuel cell units it is necessary that these are inexpensive to produce, are reliable, have a high efficiency and are also compact. The aim of the present invention is to provide a fuel cell unit with which a fuel cell stack can be produced that meets these requirements.

This aim is realised for a fuel cell unit in that the gas feed/discharge for the anode comprises channels extending through the separator plates, in that the gas feed/discharge for the cathode comprises channels extending from the cathode to beyond the peripheral boundary of the separator plates, wherein the gas feed and the gas discharge for the cathode and anode gases are arranged on the same side of the cell unit and wherein said seal comprises a metal wire, wherein there is an insulator at the point of contact with said metal wire.

As a result of the use of a metal wire, a relatively high specific pressure can be applied at the location of the wire with a relatively low force on a stack, as a result of which this accurately adapts to the conditions and a good seal can be guaranteed. That is to say, sufficient contact force (without exceeding the mechanical strength of the stack) remains for electrical contact. As a result of the appreciable possibilities for deformation of a metal wire, thickness tolerances can be absorbed in a simple manner, as a result of which less stringent requirements are imposed on the components concerned.

With the present invention it is possible to use relatively inexpensive materials. Ferritic stainless steel, which is certainly very effective up to temperatures of approximately 800° C., is mentioned as an example. A further step to limit the costs as far as possible is the use of relatively flat components, which can be produced by punching. The use of expanded metal can also have the effect of reducing costs. Furthermore, with the construction in question it is possible to work with relatively large production tolerances, as a result of which the production costs fall further.

In principle, two seals are adequate for the construction according the present invention. Leakage of anode and cathode gases in an undesired manner is prevented with the aid of this double seal. Furthermore, such seals consisting of metal wires provide some flexibility. Metallic material such as silver adheres particularly well to the materials concerned. Moreover, the flexibility is essentially retained even after undergoing a few thermal cycles, as a result of which the reliability further increases.

The present invention makes use of internal manifolding and sealing of the fuel gas. As a result leakage of fuel gases is prevented as far as possible, which contributes to a high voltage and thus a high efficiency. As a result of the construction according to the present invention, good gas flow distribution over the cell and between the cell units in the stack is possible, which further promotes the voltage and enables high utilisation of the fuel gas. As a result of the parallel flow of gases past the anode and cathode, a better temperature and current density distribution is obtained compared with cross-current and counter-current, which enables a high voltage with high utilisation.

By feeding the oxygen-containing cathode gas externally an appreciable saving in space in a cell stack can be obtained compared with the situation in which manifolding is used.

With the abovementioned combination it is possible, on the one hand, that the fuel gases, are used in the optimum possible manner and, on the other hand, the supply of the air-containing gas is carried out in as compact a manner as possible.

The cell unit according to the present invention can contain both anode-supported, electrolyte-supported and metal-supported solid oxide fuel cells. The thickness of the sealing wire, such as a silver wire, is preferably approximately 0.8 mm. Appreciable thickness tolerances can be absorbed by applying pressure to the fuel cell stack made up of fuel cell units in combination with the flexible seal. A value of approximately 50 μm between two adjacent surfaces to be sealed is mentioned as an example. Because the various elements of the stack have some flexibility, leakage will not immediately be produced in the case of relatively slight deformation.

There is an electrical insulator between the seal and the adjacent plate. Such an insulator can be a separate component (such as a sheet of mica) or a coating with an electrically insulating action that is applied to the plate. The thickness of such a coating is preferably approximately 100 μm and more particularly approximately 200 82 m thick.

As described above, the fuel cell unit according to the present invention is particularly suitable for use in a system. In this case according to an advantageous embodiment of the invention a number of stacks are used alongside one another. As an example three stacks are placed next to one another. The cathode gas originating from the first stack is fed directly to the next stack, after cooling if necessary. Such cooling preferably takes place by adding a small amount of cold air.

In this way the fuel gas is able to move (via insulating material) directly from the one stack to the other stack. It is not necessary to collect the gas and then to distribute it again. By adding cooling air if necessary, the use of a heat exchanger can be avoided and the oxygen concentration is maintained to the last stack. In this way heating of the air is necessary only in the first stack, as a result of which the number of heat exchangers and the size thereof can be restricted.

The size of the cell can be chosen depending on the desired generated current. A value of 10×10 or 20×20 cm is mentioned as an example.

The invention also relates to a fuel cell stack consisting of a number of fuel cells as described above. Feed/discharge of the anode gases can be carried out internally in the manner described above, whilst cathode gases can be fed/discharged externally. The space in which the cell is located can be insulated and such an insulation can at the same time function for internal control of the air stream. Complete sealing of the stack of cells and the insulating material is not necessary provided that the insulating material provides a leak-tight closure. Air moving over the stack can possibly also contribute to cooling of the stack concerned. The entire residual air stream that issues from the final stack can be fed through a heat exchanger to warm the gases entering the system.

The invention will be explained in more detail below with reference to an illustrative embodiment shown in the drawing. In the drawing:

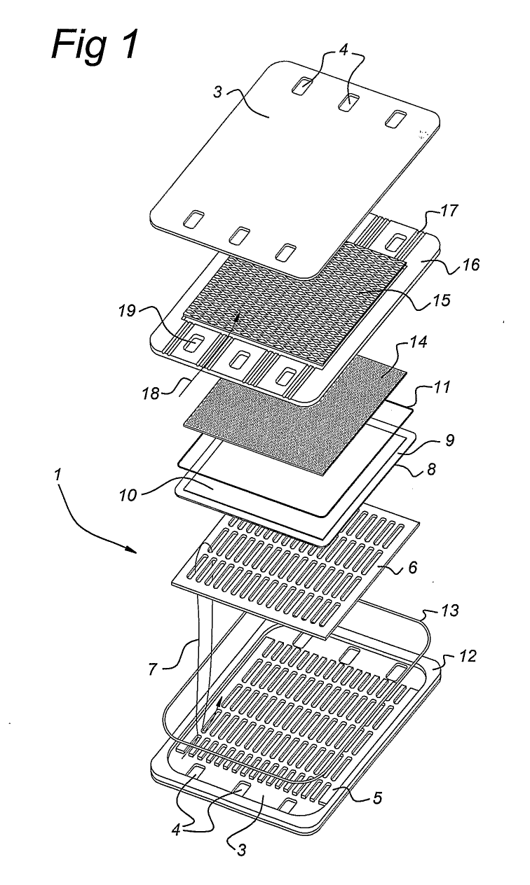

FIG. 1 shows the various components of a fuel cell;

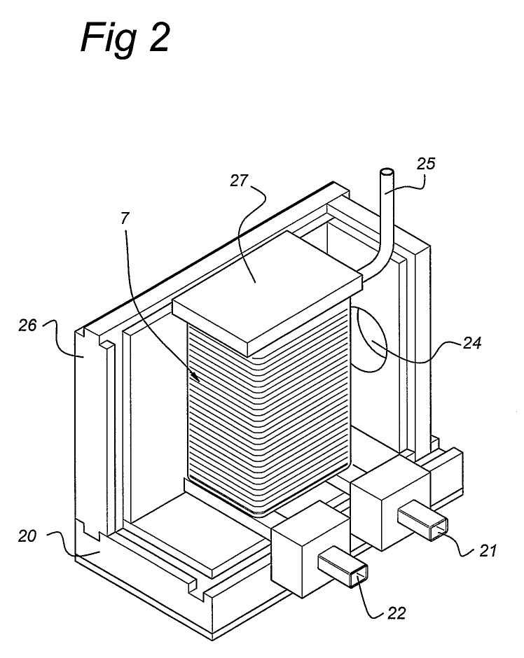

FIG. 2 shows a fuel cell stack in a partially exposed view; and

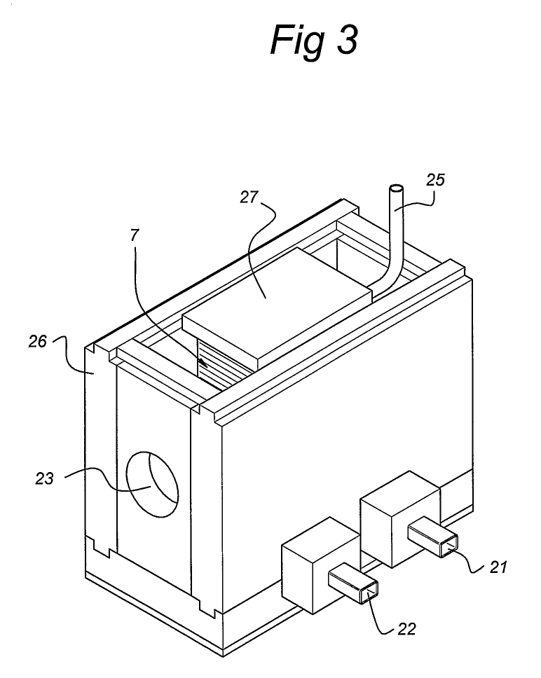

FIG. 3 shows a complete fuel cell stack.

In FIG. 1 an SOFC fuel cell unit is indicated by 1. This is delimited at both the bottom and the top by a separator plate 3, which is part of the fuel cell unit. This can be a simple punched part made of stainless steel, such as ferritic stainless steel. This plate is provided with openings 4, delimited therein, for feeding anode gas on one side and removal thereof on the other side. A first and second anode grid plate 5 and 6, respectively, are arranged on the bottom separator plate 3 in the drawing. These plates are so positioned that channels are produced that join the openings 4 to the anode to be described below. Arrow 7 shows the path of the gas as an example. This path can have any other pattern, which, moreover, can be achieved in another way. Furthermore, these grid plates function as “current collector”. That is to say the flow originating from the anode surface is transmitted via the first and second anode grid plates to the separator plate. These two plates 5, 6 can be replaced by a single plate. Instead of the simple punched part shown, such a plate can, for example, be made of expanded metal.

The present example relates to an anode-supported cell. That is to say the anode 8 is made relatively thick. The anode has a thickness between 100 and 2000 μm and is made of nickel, to which YSZ can be added. A relatively thin layer (5-10 μm) of electrolyte, which can (partly) be made of the same material, is applied to the anode 8. A thin (15-50 μm) cathode 10 is, in turn, applied to the electrolyte. It must be understood that the invention is not restricted to anode-supported cells. Electrolyte-supported fuel cells and metal-supported cells can be used.

It can be seen from the drawing that the cathode 10 has a substantially smaller size than the anode/electrolyte combination 8, 9, so that there is a residual peripheral edge. A peripheral seal 11, such as a silver wire, bears on said peripheral edge, which seal, on the other side, supports the auxiliary plate 16 described below.

A spacer 12 is arranged on the outside of the separator plate 3. The fixing can comprise soldering, such as is achieved by placing a solder foil between them. The actual fuel cell just described, consisting of anode-electrolyte-cathode and the associated first and second anode grid plate, is defined inside therein, as well as the first and second cathode grid plate 14 and 15, respectively, placed on the cathode. The first and second cathode plate can be replaced by any other construction that is able to fulfil the function of gas distributor, current collector and force distributor.

A peripheral seal 13, such as a silver wire, is arranged on the spacer 12. Instead of a solid silver wire and spacer 12, any other seal, such as a hollow Q- or C-ring, can be used for peripheral seal 13.

There must be no electrical contact between plate 16 and plate 3, which in this example is achieved by the use of mica between the bottom of the plate 16 and sealing wire 13.

An auxiliary plate 16 is placed on the spacer 12 with the seal 13 between them. The auxiliary plate 16 is provided with openings 19 which, in the case of correct positioning, are in line with the openings 4 and now also serve for unimpeded transport of anode gas. Furthermore, the auxiliary plate is provided with channels 17 which extend from the outer periphery to the first and second cathode grid plates 14, 15. The first and second cathode grid plates are essentially the same size as the cathode, that is to say are smaller than the dimensions of the anode. As a result the opening of the channels 17 is at the electrolyte/anode component protruding relative to the cathode, that is to say within the space formed by the peripheral seal. As a result cathode gas is not able to leak to the anode. The path of the gas fed is indicated by 18.

Plate 16 is affixed to plate 3 directly with, for example, soldering (foil). This direct join forms a simple but perfect seal for separating the cathode gas and the anode gas from the internal anode manifolding, on the one hand, and the cathode gas towards the surroundings of the stack, on the other hand

The cell unit is thus complete and the spacer 12 and anode grid plate of a subsequent cell unit are then placed on separator plate 3. The anode gas to be fed/discharged can never come into contact with the cathode because of the seal 11 between auxiliary plate 16 and electrolyte 9. There is a gap between the separator plate 3 and the auxiliary plate 16 only at the location of the spacer 12. In this gap the anode gas can reach the anode via the first and second anode grid plate and can then be discharged therefrom again. Auxiliary plate 16 is sealed off from this gap with the peripheral seal 11. Further sealing takes place with the peripheral seal 13. The critical region from which gas can issue if necessary is thus completely sealed off. It will be understood that “external manifolding” is provided via the channels 17 in auxiliary plate 16.

In FIG. 2 a cell stack is indicated by 7. FIG. 2 is partially exposed, whilst FIG. 3 shows the complete construction. This consists of a number of such as, for example sixty, fuel cell units described above. These are on a support 20. The anode gas feed is indicated by 22, whilst the anode gas discharge is indicated by 21. These adjoin the openings 4 described above on either side of the fuel cell in order to provide feed and discharge of anode gas, respectively. As described above, the feed of cathode gas takes place with external manifolding, that is to say the cell stack 1 is placed in an enclosed chamber and an oxygen-containing gas, such as air, is fed to one side and then discharged on the other side. This enclosure is preferably effected using plates of gas-tight insulating material 26. The take off of current is shown by 25, whilst a pressure plate is indicated by 27. 23 indicates an air feed channel.

The cell unit described above can be built up using components that are easy to produce. The various plates can, for example, be produced by punching. An alternative, which is used in particular for the gas distributor plates, is the use of expanded metal, which is available inexpensively. Because the channels 17 do not have to be closed on all sides, these can also be made in the auxiliary plate 16 in a simple manner. The production of an anode-supported fuel cell is part of the state of the art and can be achieved in a simple manner.

After reading the above, modifications consisting of the use of the known construction with the fuel cell/fuel cell stack described above will be immediately apparent to those skilled in the art. Such variants fall within the scope of the appended claims.

1-14. (canceled)

15. A solid oxide fuel cell unit comprising an electrolyte with an anode on one side and a cathode on the other side, each provided with a flow/gas distribution grid with gas feed/discharge, wherein a separator plate is adjacent each grid, as well as a seal acting on the separator plate, the gas feed/discharge for the anode comprising channels extending through the separator plates, in that the gas feed/discharge for the cathode comprises channels extending from the cathode to beyond the peripheral boundary of the separator plates, wherein the gas feed and the gas discharge for the cathode and anode gases are arranged on the same side of the cell unit and wherein said seal comprises a metal wire, wherein there is an insulator at the point of contact with said metal wire.

16. The fuel cell unit according to claim 15, having an auxiliary plate, of essentially the same size as said separator plates, arranged between said separator plates, which auxiliary plate is provided with an opening within which the cathode grid is accommodated.

17. The fuel cell unit according to claim 16, wherein said auxiliary plate is provided with slots, which delimit the gas feed/discharge for cathode gas.

18. The fuel cell unit according to claim 16, wherein a solder join between auxiliary plate and the separator plate forms the seal between the cathode gas and the anode gas from the internal anode manifolding, on the one hand, and the cathode gas and the surroundings, on the other hand.

19. The fuel cell unit according to claim 15, having a spacer arranged on the separator plate, wherein a solder join between said spacer and separator plate forms part of the seal for the anode gas to the surroundings.

20. The fuel cell unit according to claim 15, wherein the flow/gas distribution grid for the cathode has a smaller size than the size of the anode/electrolyte, and the flow/gas distribution grid of the anode, respectively.

21. The fuel cell unit according to claim 17, wherein there is a peripheral seal between said auxiliary plate and the electrolyte arranged on the anode (support), the auxiliary plate and the electrolyte being electrically insulated with respect to one another.

22. The fuel cell unit according to claim 15, wherein said cathode is within the peripheral boundary of the anode and a metallic peripheral seal is arranged between the periphery of said anode and said separator plate.

23. The fuel cell unit according to claim 15, wherein said separator plate and auxiliary plate are punched parts.

24. The fuel cell unit according to claim 15, wherein said metal wire is silver.

25. The fuel cell unit according to claim 15, wherein a spacer is arranged between said auxiliary plate and said separator plate.

26. The fuel cell unit according to claim 15, wherein said insulator is made of mica.

27. A cell stack comprising at least twenty-five solid oxide fuel cell units, each cell unit comprising an electrolyte with an anode on one side and a cathode on the other side, each provided with a flow/gas distribution grid with gas feed/discharge, wherein a separator plate is adjacent each grid, as well as a seal acting on the separator plate, the gas feed/discharge for the anode comprising channels extending through the separator plates, in that the gas feed/discharge for the cathode comprises channels extending from the cathode to beyond the peripheral boundary of the separator plates, wherein the gas feed and the gas discharge for the cathode and anode gases are arranged on the same side of the cell unit and wherein said seal comprises a metal wire, wherein there is an insulator at the point of contact with said metal wire, said fuel cell units being arranged on top of one another with a common separator plate in each case.

28. The cell stack according to claim 27, having pressure means acting in a direction perpendicular to the separator plate surface.
